(19) United States
(12) Patent Application Publication
(10) Pub. No.: US 2005/0049316 A1
(43) Pub. Date: Mar. 3, 2005

(54) Emulsified water fuel blend containing an aqueous organic ammonium salt

(76) Inventors: James D. Burrington, Mayfield, OH (US); Daniel T. Daly, Solon, OH (US); Scott T. Jolley, Mentor, OH (US); Daniel H. Heath, Ravenna, OH (US)

Correspondence Address: Teresan Gilbert;The Lubrizol Corporation, Patent Dept./Mail Drop 022B, 29400 Lakeland Blvd., Wickliffe, OH, 44092-2298, US

(21) Appl. No.: 10/945,287

(22) Filed: Sep. 20, 2004

Related U.S. Application Data
(63) Continuation of application No. 10/201,008, filed on Jul. 23, 2002.

(51) Int. Cl. B01F 17/18; C10L 1/32

(52) U.S. Cl. 516/27; 44/301

(57) ABSTRACT

The invention relates to an emulsified water fuel blend containing aqueous organic ammonium salts. The emulsified water fuel blend lowers nitrogen oxide emissions from engines.

### FIELD OF THE INVENTION

The invention relates to an emulsified water in fuel that reduces emissions by the incorporation of a selective reductant component in the emulsified fuel. More particularly, the invention relates to the use of an aqueous organic ammonium salt in an emulsified fuel to reduce emissions, improve emulsion stability and blend faster. The term emulsified fuel means the same as the terms water in fuel, aqueous fuel, water fuel blends, emulsified water in fuel/oil, water fuel emulsion, water in fuel emulsion, water blended fuel and the like.

### BACKGROUND OF THE INVENTION

Internal combustion engines, especially diesel engines, using water fuel blends in the combustion chamber can produce lower nitrogen oxides (NOₓ), hydrocarbons and particulate matter emissions. NOₓ are an environmental issue because they contribute to smog and air pollution. Governmental regulations and environmental concerns have driven the need to reduce NOₓ emissions from engines. In particular, the U.S. Clean Air Act will require about 90% to 95% reduction of the current level of emissions by 2007. Similar regulations are expected in Europe and other parts of the industrialized world.

The use of emulsified fuels to reduce emissions has been disclosed in other patent applications of Applicant, see U.S. Pat. Nos. 6,383,237, 6,368,367, 6,368,366 and 6,280,485 all incorporated herein by reference.

Selective catalytic reductants (SCR) have been used to reduce emissions from diesel engines for industrial and stationary applications, see Diesel Net Technology Guide, “Diesel Catalysts; Selective Catalytic” at http://www.dieselnet.com/tq.html. However, proposed SCR systems have many problems and obstacles to overcome due to the size, complexity and costs of the SCR systems.

It has been found that the incorporation of an aqueous organic salt into an emulsified fuel provides for NOx reduction in engines. Additionally, the aqueous organic salt improves the stability of the emulsified fuel and matches the index of refraction more closely to the base fuel used in the emulsified fuel.

### SUMMARY OF THE INVENTION

The invention relates to an emulsified fuel comprising water, fuel, at least one emulsifier and at least one aqueous organic ammonium salt resulting in a water in fuel emulsion. The resulting emulsified fuel has reduced NOx emissions and improved stability over other water in fuel blends. Further, the resulting emulsified fuel can be blended faster into an emulsification than other water blended fuels, due to lower levels of water in the fuel.

Further, the invention relates to a process for making the emulsified fuel comprising emulsifying a fuel, water, at least one emulsifier and at least one organic ammonia salt in the aqueous phase.

The invention further relates to a process for the production of the emulsified fuel from a concentrate comprising mixing a portion of the fuel, substantially all of the emulsifier, substantially all of the water, substantially all of the organic ammonium salt to form a concentrated emulsified water blended fuel; and then diluting the concentrated emulsified fuel with the remaining portion of fuel.

### DETAILED DESCRIPTION OF THE INVENTION

The invention discloses the reduction of emissions in engines operated with emulsified fuels. The emulsified fuel is described more thoroughly in U.S. Pat. No. 6,280,485 entitled “Emulsified Water-Blended Fuel Composition” and U.S. Pat. No. 6,383,237 entitled “Process And Apparatus For Making Aqueous Hydrocarbon Fuel Composition And Aqueous Hydrocarbon Fuel Composition” and U.S. Ser. No. 09/761,482 entitled “Emulsifier For An Aqueous Hydrocarbon Fuel” all incorporated herein and assigned to assignee of the present application. The invention herein employs an aqueous organic ammonium salt component to the water blended fuel. The use of the aqueous organic ammonium salt component reduces NOₓ emissions, more closely matches the index refraction of the aqueous particles to the base fuel resulting in optical clarity, and improves the stability of the emulsified fuel and reduces engine emissions.

The organic ammonium salt includes but is not limited to the formula 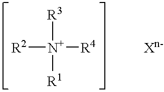
in which R¹, R², R³ and R⁴ are identical or different and independently of one another are hydrogen; or an organic substitute having up to 18 C atoms which is bonded via a C—N bond; or a saturated or unsaturated alkyl group, aryl group, or saturated or unsaturated alkyl group, aryl group substituted with a heteroatom selected from the group comprising N, O, S, P, and a halogen atoms, where R averages from about 4 to about 20 carbon atoms, preferably from about 7 to about 12 carbon atoms; or at least one of the radicals R¹, R², R³ and R⁴ being other than hydrogen and Xⁿ⁻ being an anion of an inorganic or organic n-basic acid, and n being 1, 2, or 3.

Xⁿ⁻ includes but is not limited to anions whose conjugate acids of the formula HₙX having a pka <10; halogen atoms and the like. Exemplary aqueous organic Xⁿ⁻ are selected from the group of chlorine and bromine, or X is an anion of a protic acid, which may include but is not limited to, carboxylic acids, perchloric acid, carbonic acid and mixtures thereof.

Specific examples of organic ammonium salts includes but are not limited to hydroxides, sulfates, sulfites, paratoluenesulfonates, nitrates, acetates, tetramehl ammonium, halids of tetramethylammonium, sulfates of ammonia, nitrates of ammonia, acetates of ammonia, halides of ammonia, N,N-dimethyloctylammonium chloride, N,N-dimethyidecylammoniumchloride and the like. Additional examples of organic ammonium salts that may be suitable include but are not limited to ammonium alkanoates (typically C.sub.1 to C.sub.20), alkylammonium compounds having 1 to 6 carbon atoms, ammonium benzoates, ammonium sulfonates, ammonium phosphonates, ammonium chlorates, ammonium salts of other aromatic or heteroaromatic carboxylic acids and the like.

Exemplary primary organic ammonium salts include but are not limited to stearlammonium acetate (Genamin®-SH 500 A), oleylammonium acetate (Genamin®-OL 500 A), tallow fatty amine acetate (Gernamin®-TA 500 A), coconut fatty amine oleate (Genamin®-CC 500 E), coconut fatty amine acetate (Genamin®-CC 500 A) and tallow fatty propylenediaminoacetate (Genamin®-TAP 500 E).

Exemplary secondary organic ammonium salts include but are not limited to Pr apagen® WKL brands (a range of dialkylammonium chlorides).

Exemplary tertiary organic ammonium salts include but are not limited to cetyldimethylammonium chloride or oleyldimethylammonium chloride.

Exemplary quaternary organic ammonium salts include but are not limited to hexadecyltrimethylammonium chloride (dodigen 1382®), hexadecyltrimethylammonium chloride (Dodigen 2544®), soya alkyltrimethylammonium chloride (Dodigen 5594®), coconut alkyldimethylbenzylammonium chloride (Dodigen 226®), coconut alkyldimethylbenzylammonium chloride (dodigen 5462®), coconut alkyl-2,4-dichlorobenzyldimethylammonium chloride (Dodigen 1509®), stearyldimethylbenzylammonium chloride (Dodigen 1828®), di-coconut alkyldimethylammonium chloride (didigen 490®), disteryldimethylammoniumchloride (Prapagen WK®), quaternary dialkylammonium chloride (Prapagen WKL®), di-tallow fatty alkyldimethylammonium chloride (Prapagen WKT®), Dodigen®, Prapagen®, and Genamin®-K brands such as Genamin®-KDM-F (a series of alkyltrimethylammonium chlorides) or distearyidimethylammonium chloride (Genamin®-DSAC) and didecylmethylpolyoxyethylammonium propionate (Dodigen® 3519), Prapgen® WK 1852, WKL, WKT (a series of di-fatty acid dimethylammonium chlorides), a various benzyltrimethylammonium chlorides of the Dodigen® 1611 and 2809 types.

The primary, secondary, tertiary and quaternary ammonium salts as well as other which are suitable according to the invention are described in McCutcheon's-Emulsifiers & Detergents. (1991), Glen Rock.

The organic ammonium salt is separate and distinct from the ammonium salts that can be used in the emulsifier (iv). Combinations of the organic ammonium salt may be used. The organic ammonium salts are in the range of about 0.1% to about 35% by weight, preferably about 0.5% to about 10% by weight, and more preferably about 1 % to about 5% by weight of the emulsified fuel.

The emulsified fuel is comprised of a continuous fuel phase, a discontinuous water or aqueous phase, an emulsifying amount of an emulsifier, and a nitrate reducing organic salt. The emulsions may contain other additives that include but are not limited to cetane improvers, organic solvents, antifreeze agents and the like. The invention provides a batch, semi-batch or continuous process for making the emulsified fuel by forming a stable emulsion in which the water phase is suspended in a continuous phase of fuel. The water phase of the emulsified fuel is comprised of droplets having a mean diameter of 1.0 micron or less, in another embodiment 0.8 microns or less, in another embodiment 0.1 microns or less. The emulsification generally occurs by shear mixing and is conducted under sufficient conditions to provide such a droplet size.

The emulsified fuel may be prepared by the steps of mixing the fuel, at least one emulsifier and other desired additives using standard mixing techniques to form a fuel additives mixture; and then the fuel additives mixture is mixed with water and at least one of an organic ammonium salt and optionally an antifreeze agent or soluble additives under emulsification conditions to form the desired emulsified fuel. Alternatively, a concentrate is formed in that all or substantially all the water, organic ammonium salt, and a portion of the fuel and all or substantially all the emulsifier is blended to form a concentrate of the emulsified fuel. The emulsified fuel, when used, is then blended with the rest of the fuel. Other water-soluble and hydrocarbon-soluble additives may be added to the concentrate, the final emulsified fuel or combinations thereof.

The fuel comprises hydrocarbonaceous petroleum distillate fuel, non-hydrocarbonaceous materials that include but are not limited to water, oils, liquid fuels derived from vegetables, liquid fuels derived from minerals and mixtures thereof. Suitable fuels include, but are not limited to, gasoline, diesel, kerosene, naphtha, aliphatics and paraffin. The fuel comprises non-hydrocarbonaceous materials include but is not limited to alcohols such as methanol, ethanol and the like, ethers such as diethyl ether, methyl ethyl ether and the like, organo-nitro compounds and the like; fuels derived from vegetable or mineral sources such as corn, alfalfa, shale, coal and the like. The fuel also includes but is not limited to gas to liquid fuels. The fuel also includes but is not limited to mixtures of one or more hydrocarbonaceous fuels and one or more non-hydrocarbonaceous materials. Examples of such mixtures are combinations of gasoline and ethanol and of diesel fuel and ether and the like.

In one embodiment, the fuel is any gasoline. Including, but not limited to a chlorine-free gasoline or a low-chlorine gasoline, or a low sulfur gasoline or sulfur-free gasoline and the like.

In one embodiment, the fuel is any diesel fuel. The diesel fuels include, but are not limited to, those that contain alcohols and esters, has a sulfur content of up to about 0.05% by weight or sulfur-free, is a chlorine-free or low-chlorine diesel fuel and the like.

The fuel is present in the emulsified fuel at a concentration of about 50% to about 95% by weight, and in one embodiment about 60% to about 95% by weight, and in one embodiment about 65% to about 85% by weight, and in one embodiment about 80% to about 90% by weight of the emulsified fuel.

The water used in the emulsified fuel may be taken from any source. The water includes but is not limited to tap, deionized, demineralized, purified, for example, using reverse osmosis or distillation, and the like. The water includes water mixtures that further includes but are not limited to antifreeze components such as alcohols and glycols, ammonium salts such as ammonium nitrate, ammonium maleate, ammonium acetate and the like, and combinations thereof; and other water soluble additives.

The water is present in the emulsified fuel at a concentration of about 1% to about 50% by weight, in one embodiment about 5% to about 40% being weight, in one embodiment about 5% to about 25% by weight, and in one embodiment about 10% to about 20% by weight of the emulsified fuel.

The emulsifier includes but is not limited to
(i) at least one fuel-soluble product made by reacting at least one hydrocarbyl-substituted carboxylic acid acylating agent with ammonia or an amine including but not limited to alkanol amine, hydroxy amine, and the like, the hydrocarbyl substituent of said acylating agent having about 50 to about 500 carbon atoms;
(ii) a second-acylating agent having at least one hydrocarbyl substituents of up to about 40 carbon atoms, and reacting that said acylating agent with ammonia or an amine;
(iii) at least one of an ionic or a nonionic compound having a hydrophilic-lipophilic balance (HLB) of about 1 to about 40;
(iv) mixture of (ii) or (iii) with (i) or a mixture of (i), (ii), and (iii);
(v) a water-soluble compound selected from the group consisting of amine salts, ammonium salts, azide compounds, nitrate esters, nitramine, nitrocompounds, alkali metal salts, alkaline earth metal salts, in combination with (i), (ii), (iii), (v), (vii) or combinations thereof;
(vi) the reaction product of polyacidic polymer with at least one fuel soluble product made by reacting at least one hydrocarbyl-substituted carboxylic acid acylating agent with ammonia, an amine, a polyamine, an alkanol amine or hydroxy amines;
(vii) an amino alkylphenol which is made by reacting an alkylphenol, an aldehyde and an amine resulting in an amino alkylphenol, or
(viii) the combination of (i), (ii), (iii), (iv), (vi), (vii) or combinations thereof.

The fuel-soluble product (i) of the emulsifier may be at least one fuel-soluble product made by reacting at least one hydrocarbyl-substituted carboxylic acid acylating agent with ammonia or an amine including but not limited to alkanol amines, hydroxy amines, and the like, the hydrocarbyl substituent of said acylating agent having about 50 to about 500 carbon atoms, and is described in greater detail in U.S. Ser. No. 09/761,482, An Emulsifier For An Aqueous Hydrocarbon Fuel, incorporated by reference herein.

The hydrocarbyl-substituted carboxylic acid acylating agents may be carboxylic acids or reactive equivalents of such acids. The reactive equivalents may be acid halides, anhydrides, or esters, including partial esters and the like. The hydrocarbyl substituents for these carboxylic acid acylating agents may contain from about 50 to about 500 carbon atoms, and in one embodiment about 50 to about 300 carbon atoms, and in one embodiment about 60 to about 200 carbon atoms. In one embodiment, the hydrocarbyl substituents of these acylating agents have number average molecular weights of about 700 to about 3000, and in one embodiment about 900 to about 2300.

In another embodiment, the fuel soluble product (i) of the present invention comprises an emulsifying amount of at least one of a fuel-soluble hydrocarbyl-substituted carboxylic acylating agent and a reaction product of said acylating agent with at least one of ammonia, an amine, an alcohol, a reactive metal, a reactive metal compound or a mixture of two or more thereof, wherein the hydrocarbyl substituent comprises a group derived from at least one polyolefin, said polyolefin having \overline{M}_{w}/\overline{M}ₙ greater than about 5.

The hydrocarbyl substituted acylating agents have a hydrocarbyl group substituent that is derived from a polyolefin, with polydispersity and other features as described below. Generally, it has a number average molecular weight of at least 600, 700, or 800, to 5000 or more, often up to 3000, 2500, 1600, 1300, or 1200. Typically, less than 5% by weight of the polyolefin molecules have \overline{M}ₙ less than about 250, more often the polyolefin has \overline{M}ₙ of at least about 800. The polyolefin preferably contains at least about 30% terminal vinylidene groups, more often at least about 60% and more preferably at least about 75% or about 85% terminal vinylidene groups. The polyolefin has polydispersity, \overline{M}_{w}/\overline{M}ₙ, greater than about 5, more often from about 6 to about 20. The hydrocarbyl group is typically derived from a polyolefin or a polymerizable derivative thereof, including homopolymers and interpolymers of olefin monomers having 2 to 30, to 6, or to 4 carbon atoms, and mixtures thereof. In a preferred embodiment the polyolefin is polyisobutenyl.

Suitable olefin polymer hydrocarbyl groups, having suitable polydispersity, can be prepared by heteropolyacid catalyzed polymerization of olefins under conventional conditions. Preferred heteroplyacids include a phosphotungstic acid, a phosphomolybidc acid, a silicotungstic acid, a silicomolybdic acid and the like.

The hydrocarbyl-substituted carboxylic acid acylating agents may be made by reacting one or more alpha-beta olefinically unsaturated carboxylic acid reagents containing 2 to about 20 carbon atoms, exclusive of the carboxyl groups, with one or more olefin polymers as described more fully hereinafter.

In one embodiment, the hydrocarbyl-substituted carboxylic acid acylating agent is a polyisobutene-substituted succinic anhydride, the polyisobutene substituent having a number average molecular weight of about 1,500 to about 3,000, in one embodiment about 1,800 to about 2,300, in one embodiment about 700 to about 1300, in one embodiment about 800 to about 1000, said first polyisobutene-substituted succinic anhydride being characterized by about 1.3 to about 2.5, and in one embodiment about 1.7 to about 2.1 In one embodiment, the hydrocarbyl-substituted carboxylic acid acylating agent is a polyisobutene-substituted succinic anhydride, the polyisobutene substituent having a number average molecular weight of about 1,500 to about 3,000, and in one embodiment about 1,800 to about 2,300, said first polyisobutene-substituted succinic anhydride being characterized by about 1.3 to about 2.5, and in one embodiment about 1.7 to about 2.1, in one embodiment about 1.0 to about 1.3, and in one embodiment about 1.0 to about 1.2 succinic groups per equivalent weight of the polyisobutene substituent.

The fuel-soluble product (i) may be formed using ammonia, an amine and/or metals such as Na, K, Ca, and the like. The amines useful for reacting with the acylating agent to form the product (i) including but are not limited to, monoamines, polyamines, alkanol amines, hydroxy amines, and mixtures thereof, and amines may be primary, secondary or tertiary amines.

Examples of primary and secondary monoamines include ethylamine, diethylamine, n-butylamine, di-n-butylamine, allylamine, isobutylamine, cocoamine, stearylamine, laurylamine, methyllaurylamine, oleylamine, N-methyloctylamine, dodecylamine, and octadecylamine. Suitable examples of tertiary monoamines include trimethylamine, triethylamine, tripropylamine, tributylamine, monoethyldimethylamine, dimethylpropylamine, dimethylbutylamine, dimethylpentylamine, dimethylhexylamine, dimethylheptylamine, and dimethyloctylamine.

The amines include but are not limited to hydroxyamines, such as mono-, di-, and triethanolamine, dimethylethanol amine, diethylethanol amine, di-(3-hydroxy propyl) amine, N-(3-hydroxybutyl) amine, N-(4-hydroxy butyl) amine, and N,N-di-(2-hydroxypropyl) amine; alkylene polyamines such as methylene polyamines, ethylene polyamines, butylene polyamines, propylene polyamines, pentylene polyamines, and the like. Specific examples of such polyamines include ethylene diamine, diethylene triamine, triethylene tetramine, propylene diamine, trimethylene diamine, tripropylene tetramine, tetraethylene pentamine, hexaethylene heptamine, pentaethylene hexamine, or a mixture of two or more thereof; ethylene polyamine; is a polyamine bottoms or a heavy polyamine. The fuel-soluble product (i) may be a salt, an ester, an ester/salt, an amide, an amide, or a combination of two or more thereof.

The fuel-soluble product (i) may be present in the water fuel emulsion at a concentration of up to about 15% by weight based on the overall weight of the emulsion, and in one embodiment about 0.1 to about 15% by weight, and an one embodiment about 0.1 to about 10% by weight, and in one embodiment about 0.1 to about 5% by weight, and in one embodiment about 0.1 to about 2% by weight, and in one embodiment about 0.1 to about 1% by weight, and in one embodiment about 0.1 to about 0.7% by weight.

The second acylating agent (ii) of this invention includes carboxylic acids and their reactive equivalents such as acid halides and anhydrides.

In one embodiment, the carboxylic acid is a monocarboxylic acid of about 1 to about 35 carbon atoms, and in one embodiment about 16 to about 24 carbon atoms. Examples of these monocarboxylic acids include lauric acid, oleic acid, isostearic acid, palmitic acid, stearic acid, linoleic acid, arachidic acid, gadoleic acid, behenic acid, erucic acid, tall oil fatty acids, lignoceric acid and the like. These acids may be staturated, unsaturated, or have other functional groups, such as hydroxy groups, as in 12-hydroxy stearic acid, from the hydrocarbyl backbone.

In one embodiment, the carboxylic acid is a hydrocarbyl-substituted succinic acid represented correspondingly by the formula 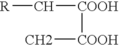
wherein formula R is hydrocarbyl group of about 12 to about 35, and in one embodiment from about 12 to about 30, and in one embodiment from about 16 to about 24 and in one embodiment from about 26 to about 35 carbon atoms. The production of such hydrocarbyl-substituted succinic acids or anhydrides via alkylation of maleic acid or anhydride or its derivatives with a halohydrocarbon or via reaction of maleic acid or anhydride with an olefin polymer having a terminal double bond is known to those of skill in the art.

In one embodiment, the acylating agent (ii) is a carboxylic acid or the acylating agent (ii) used to prepare carboxylic acid and is made by reacting one or more alpha-beta olefinically unsaturated carboxylic acid reagents containing about 2 to about 20 carbon atoms, exclusive of the carboxyl based groups, with one or more olefin polymers containing at least about 16 carbon atoms.

In the one embodiment, the ratio of the first acylating agent (i), to the second acylating agent (ii) in the emulsified fuel is in the range of about 9:1 to about 1:9; in another embodiment in the range of about 5:1 to about 1:5; and in another embodiment in the range of about 1:3 to about 3.1.

The ionic or nonionic compound (ii) of the emulsifier has a hydrophilic-lipophilic balance (HLB, which refers to the size and strength of the polar (hydrophilic) and non-polar (lipophilic) groups on the surfactant molecule) in the range of about 1 to about 40, and in one embodiment about 4 to about 15 and is described in greater detail in U.S. Ser. No. 09/761,482, An Emulsifier For An Aqueous Hydrocarbon Fuel, incorporated by reference herein. Examples of these compounds are disclosed in McCutcheon's Emulsifiers and Detergents, 1998, North American & International Edition. Pages 1-235 of the North American Edition and pages 1-199 of the International Edition are incorporated herein by reference for their disclosure of such ionic and nonionic compounds having an HLB in the range of about 1 to about 40, in one embodiment about 1 to about 30, in one embodiment about 1 to 20, and in another embodiment about 1 to about 10. Examples include low molecular weight variants of (i) or (vii) such as those having a hydrocarbon group in the range of C₈ or C₂₀. Useful compounds include alkanolamines, carboxylates including amine salts, metallic salts and the like, alkylarylsulfonates, amine oxides, poly(oxyalkylene) compounds, including block copolymers comprising alkylene oxide repeat units, carboxylated alcohol ethoxylates, ethoxylated alcohols, ethoxylated alkylphenols, ethoxylated amines and amides, ethoxylated fatty acids, ethoxylated fatty esters and oils, fatty esters, fatty acid amides, including but not limited to amides from tall oil fatty acids and polyamides, glycerol esters, glycol esters, sorbitan esters, imidazoline derivatives, lecithin and derivatives, lignin and derivatives, monoglycerides and derivatives, olefin sulfonates, phosphate esters and derivatives, propoxylated and ethoxylated fatty acids or alcohols or alkylphenols, sorbitan derivatives, sucrose esters and derivatives, sulfates or alcohols or ethoxylated alcohols or fatty esters, sulfonates of dodecyl and tridecyl benzenes or condensed naphthalenes or petroleum, sulfosuccinates and derivatives, and tridecyl and dodecyl benzene sulfonic acids.

The emulsifier (iii) may be a mixture of (i) and (ii) described above and is further described in detail in U.S. Ser. No. 09/761,482, An Emulsifier For An Aqueous Hydrocarbon Fuel, incorporated by reference herein.

The emulsifier of the water-soluble compound (iv) may be an amine salt, ammonium salt, azide compound, nitro compound, alkali metal salt, alkaline earth metal salt, or mixtures of two or more thereof and is described in greater detail in U.S. Ser. No. 09/761,482, An Emulsifier For An Aqueous Hydrocarbon Fuel, incorporated by reference herein. These compounds are distinct from the fuel-soluble product (i) and the ionic or nonionic compound (ii) discussed above. These water-soluble compounds include organic amine nitrates, nitrate esters, azides, nitramines and nitro compounds. Also included are alkali and alkaline earth metal carbonates, sulfates, sulfides, sulfonates, and the like.

Particularly useful are the amine or ammonium salts such as ammonium nitrate, ammonium acetate, methylammonium nitrate, methylammonium acetate, hydroxy ammonium nitrate, ethylene diamine diacetate; urea nitrate; urea; guanidinium nitrate; and combinations thereof. However, these ammonium salts of the emulsifier, if used are independent of and distinct and separate from the aqueous organic ammonium salt compound of the emulsified fuel discussed above.

In one embodiment the emulsifier (v) is the reaction product of A) a polyacidic polymer, B) at least one fuel soluble product made by reacting at least one hydrocarbyl-substituted carboxylic acid acylating agent, and C) a hydroxy amine and/or a polyamine and is described in greater detail in U.S. Ser. No. 09/761,482, An Emulsifier For An Aqueous Hydrocarbon Fuel, incorporated by reference herein.

The polyacidic polymers used in the reaction include but are not limited to C₄ to C₃₀; preferably C₈ to C₂₀ olefin/maleic anhydride copolymers; maleic anhydride/styrene copolymers; poly-maleic anhydride; acrylic and methacrylic acid containing polymers; poly-(alkyl)acrylates; reaction products of maleic anhydride with polymers with multiple double bonds;

A copolymer of an olefin and a monomer having the structure: 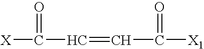
wherein X and X1 are the same or different provided that at least one of X and X₁ is such that the copolymer can function as a carboxylic acylating agent; and combinations therein.

The emulsifier produced from the reaction product of the polyacidic polymer with the fuel soluble product (i) comprises about 25% to about 95% of fuel soluble product and about 0.1% to about 50% of the polyacidic polymer; preferably about 50% to about 92% fuel soluble product and about 1% to about 20% of the polyacidic polymer, and most preferably about 70% to about 90% of fuel soluble product and about 5% to about 10% of the polyacidic polymer. In one embodiment the emulsifier is described as a polyalkenyl succinimide crosslinked with an olefin/maleic anhydride copolymer.

The amino alkyl emulsifier (vi) is comprised of the reaction product of an amino alkylphenol, an aldehyde, and an amine resulting in amino alkylphenol. The amino alkylphenol can be made by (a) the reaction of alkylphenol directly with an aldehyde and an amine resulting in an alkylphenol monomer connected by a methylene group to an amine, (b) the reaction of an alkylphenol with an aldehyde resulting in an oligomer wherein the alkylphenols are bridged with methylene groups, the oligomer is then reacted with more aldehyde and an amine to give a Mannich product, or (c) a mixture of (a) and (b) and is described in greater detail in U.S. Ser. No. 09/977,747 entitled A Continuous Process For Making An Aqueous Hydrocarbon Fuel Emulsion incorporated by reference herein.

The alkylphenols have an alkyl group selected from C₁ to C₂₀₀, preferably C₆ to C₁₇₀ wherein the alkyl group is either linear, branched or a combination thereof. The alkylphenols include, but are not limited to, polypropylphenol, polybutylphenol, poly(isobutenyl)phenol, polyamylphenol, tetrapropylphenol, similarly substituted phenols and the like. The preferred alkylphenols are tetrapropenylphenol and poly(isobutenyl)phenol.

The aldehydes include, but are not limited to, aliphatic aldehydes, such as formaldehyde; acetaldehyde; aldol (β-hydroxy butyraldehyde); aromatic aldehydes, such as benzaldehyde; heterocyclic aldehydes, such as furfural, and the like. The aldehyde may contain a substituent group such as hydroxyl, halogen, nitro and the like; in which the substituent does not take a major part in the reaction. The preferred aldehyde is formaldehyde.

The amines are those which contain an amino group characterized by the presence of at least one active hydrogen atom. The amines may be primary amino groups, secondary amino groups, or combinations of primary and secondary amino groups.

The amines include, but are not limited to, alkanolamines; di- and polyamine (polyalkyene amines); polyalkyl polyamines; propylenediamine, the aromatic amines such as o-, m- and p-phenylene diamine, diamino naphthalenes; the acid-substituted polyalkylpolyamines, and the corresponding formyl-, propionyl-, butyryl-, and the like N-substituted compounds; and the corresponding cyclized compounds formed therefrom, such as the N-alkyl amines of imidazolidine and pyrimidine. Substituent groups attached to the carbon atoms of these amines are typified by alkyl, aryl, alkaryl, aralkyl, cycloalkyl, and amino compounds. The amino alkylphenols emulsifier of this invention may be made by reacting the alkylphenol:aldehyde:amine in a ratio range of 1:1:0.1 molar to 1:2:2 molar, in one embodiment preferably 1:0.9:0.1 to 1:1.9:1.9, in one embodiment preferably 1:1.5:1.2 molar to 1:1.9:1.8 molar, and in one embodiment preferably 1:0.8:0.3 to 1:1.5:0.7, resulting in the amino alkylphenol emulsifier.

In another embodiment of this invention the amino alkylphenol is made by the reaction of an alkylphenol with an aldehyde, resulting in an oligomer wherein the alkylphenols are bridged with methylene groups; then the oligomer is reacted with more aldehyde and amine to give the emulsifier Mannich product of this invention. The reaction is prepared by any known method such as an emulsion, a solution, a suspension, and a continuous addition bulk process. The reaction is carried out under conditions that provide for the formation of the desired product.

The emulsifier is present in the emulsified fuel at a concentration of about 0.001 % to about 20% by weight, in another embodiment about 0.05% to about 10% by weight, in another embodiment about 0.1% to about 5% by weight, and in a further embodiment of about 0.01% to about 3% by weight of the emulsified fuel. Combinations of emulsifiers may be used.

In one embodiment, the emulsified fuel contains a cetane improver. The cetane improvers that are useful include but are not limited to peroxides, nitrates, nitrites, nitrocarbamates, and the like. Useful cetane improvers include but are not limited to nitropropane, dinitropropane, tetranitromethane, 2-nitro-2-methyl-1-butanol, 2-methyl-2-nitro-1-propanol, and the like. Also included are nitrate esters of substituted or unsubstituted aliphatic or cycloaliphatic alcohols which may be monohydric or polyhydric. These include substituted and unsubstituted alkyl or cycloalkyl nitrates having up to about 10 carbon atoms, and in one embodiment about 2 to about 10 carbon atoms. The alkyl group may be either linear or branched, or a mixture of linear or branched alkyl groups. Examples include methyl nitrate, ethyl nitrate, n-propyl nitrate, isopropyl nitrate, allyl nitrate, n-butyl nitrate, isobutyl nitrate, sec-butyl nitrate, tert-butyl nitrate, n-amyl nitrate, isoamyl nitrate, 2-amyl nitrate, 3-amyl nitrate, tert-amyl nitrate, n-hexyl nitrate, n-heptyl nitrate, n-octyl nitrate, 2-ethylhexyl nitrate, sec-octyl nitrate, n-nonyl nitrate, n-decyl nitrate, cyclopentyl nitrate, cyclohexyl nitrate, methylcyclohexyl nitrate, and isopropylcyclohexyl nitrate. Also useful are the nitrate esters of alkoxy-substituted aliphatic alcohols such as 2-ethoxyethyl nitrate, 2-(2-ethoxy-ethoxy) ethyl nitrate, 1-methoxypropyl-2-nitrate, 4-ethoxybutyl nitrate, etc., as well as diol nitrates such as 1,6-hexamethylene dinitrate. A useful cetane improver is 2-ethylhexyl nitrate.

The concentration of the cetane improver in the emulsified fuel is at any concentration sufficient to provide the emulsion with the desired cetane number. In one embodiment, the concentration of the cetane improver is at a level of up to about 10% by weight, and in one embodiment about 0.05% to about 10% by weight, and in one embodiment about 0.05% to about 5% by weight, and in one embodiment about 0.05% to about 1% by weight of the emulsified fuel.

In addition to the foregoing materials, other fuel additives that known to those skilled in the art may be used in the emulsified fuel. These include but are not limited to dyes, rust inhibitors such as alkylated succinic acids and anhydrides, bacteriostatic agents, gum inhibitors, metal deactivators, upper cylinder lubricants and the like.

The total concentration of chemical additives, in the emulsified fuel is from about 0.05% to about 30% by weight, and in one embodiment about 0.1% to about 20% by weight, and in one embodiment about 0.1% to about 15% by weight, and in one embodiment about 0.1% to about 10% by weight, and in one embodiment about 0.1% to about 5% by weight of the emulsified fuel.

The additives, including the foregoing emulsifiers, may be diluted with a substantially inert, normally liquid organic solvent such as naphtha, benzene, toluene, xylene or diesel fuel to form an additive concentrate which is then mixed with the fuel and water to form the emulsified fuel.

The emulsified fuel may contain up to about 60% by weight organic solvent, and in one embodiment about 0.01% to about 50% by weight, and in one embodiment about 0.01% to about 20% by weight, ahd in one embodiment about 0.1% to about 5% by weight, and in one embodiment about 0.1% to about 3% by weight of the emulsified fuel.

The emulsified fuel may additionally contain an antifreeze agent. The antifreeze agent is typically an alcohol. Examples include but are not limited to ethylene glycol, propylene glycol, methanol, ethanol, glycerol and mixtures of two or more thereof. The antifreeze agent is typically used at a concentration sufficient to prevent freezing of the water used in the water fuel emulsion. The concentration is therefore dependent upon the temperature at which the fuel is stored or used. In one embodiment, the concentration is at a level of up to about 20% by weight of the emulsified fuel, and in one embodiment about 0.1% to about 20% by weight, and in one embodiment about 1% to about 10% by weight of the emulsified fuel.

The engines that may be operated in accordance with the invention include all compression-ignition (internal combustion) engines for both mobile (including locomotive and marine) and stationary power plants. The engines may employ conventional after treatment devices. These include engines that use diesel, gasoline, and the like. The engines that can be used include but are not limited to those used in automobiles, trucks, buses, locomotives, light and heavy duty diesel engines, stationary engines and the like. Included are on- and off-highway engines, including new engines as well as in-use engines. These include diesel engines of the two-stroke-per-cycle and four-stroke-per-cycle types.

### Specific Embodiments

### EXAMPLE 1

A concentrate of aqueous ammonium maleate emulsified in diesel fuel is made by mixing the components shown in Table 1 in a Waring Blender at high sheer for 3 minutes. Attached I.

TABLE 1
Concentrate Formulation

| Components | Wt. % |
|---|---|
| | 5.07% |
| Oleic Acid (OHA) | 7.15% |
| Polyisubutenyl succinic acid (1000 Mw) | 7.05% |
| 54% wt. aqueous ammonium nitrate | 3.11% |
| 2-Ethylhexyl nitrate (EHNM) | 9.98% |
| Diethylethanolamine (DEEA) | 3.25% |
| Propyleneglycol (PRG) | 1.61% |
| Maleic Anhydride (MAA) | 19.91% |
| NH3, aqueous, 30% | 22.95% |
| Diesel Fuel Conc. Dil. | 19.95% |
| | 100.02% |

TABLE 2
Blended @ 7 wt % Concentrate

| | Wt %, final |
|---|---|
| Components in Final Fuel | fuel |
| Water | 1.25% |
| Oleic Acid | 0.51% |
| Polyisubutenyl Succinic Acid (1000 Mw) | 0.50% |
| 54% wt. aqueous ammonium nitrate | 0.22% |
| 2-Ethylhexyl nitrate (EHNM) | 0.71% |
| Diethylethanolamine (DEEA) | 0.23% |
| Propyleneglycol (PRG) | 0.12% |
| Ammonium Maleate | 2.18% |
| Diesel Fuel Conc. Dil. | 94.27% |
| | 100.00% |

TABLE 3
Engine Conditions

| Cycle No. | 59 | 57 | 55 | 53 | 51 |
|---|---|---|---|---|---|
| Torque ft-lb | 240 | 180 | 180 | 180 | 88 |
| Speed, rpm | 1800 | 1800 | 1400 | 1000 | 1000 |

TABLE 4
Water-blended Fuel - PuriNOx ® Composition

| | Wt %, |
|---|---|
| Components in Final Fuel | final fuel |
| Diesel Fuel | 77.90% |
| Water | 20.00% |
| Oleic Acid | 0.51% |
| Polyisubutenyl Succinic Acid (1000 M_{w}) | 0.50% |
| 54% wt. Aqueous Ammonium Nitrate | 0.22% |
| 2-Ethylhexyl nitrate | 0.71% |
| Diethylethanolamine | 0.23% |
| Propyleneglycol | 0.12% |
| | 100.00% |

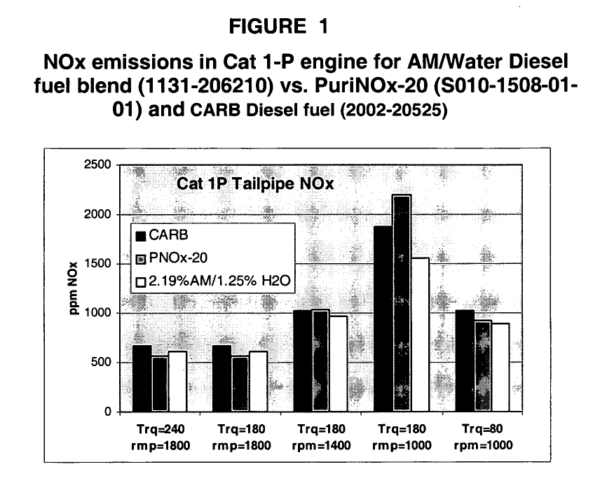

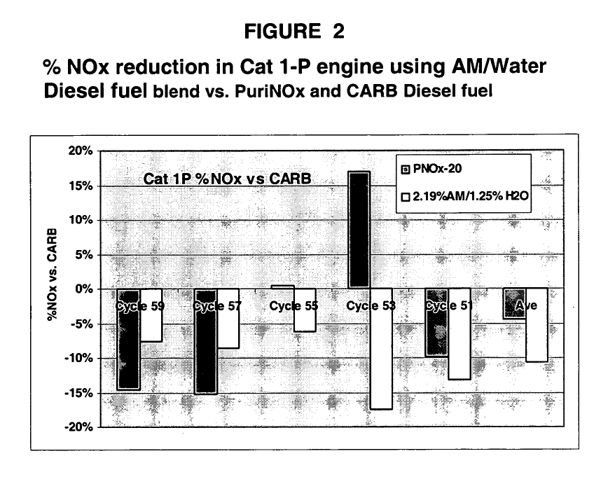

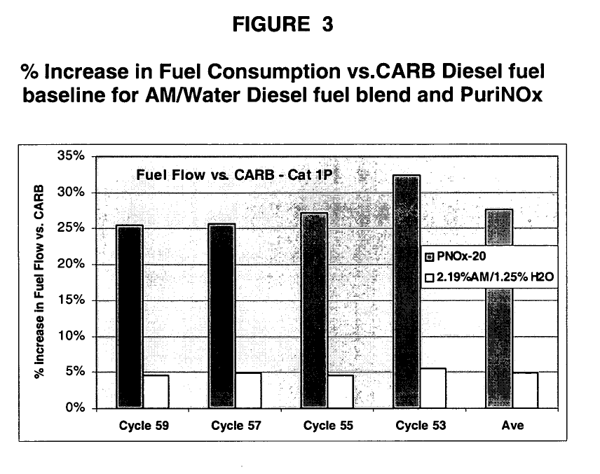

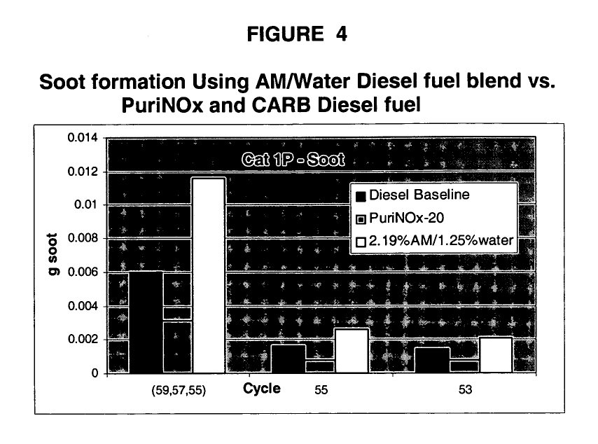

A fuel of the composition shown in Table 2 was made (give emulsification conditions). This fuel was tested in a single-cylinder Cat 1P engine as OP ID 10 to lower NOx (shown in FIGS. 1 and 2) and 95% of the fuel efficiency (FIG. 3) compared to the base fuel which is the standard California Air Resources Board Diesel Fuel (“CARB”) and a 20 wt % water PuriNOx Fuel as shown in Table 4. FIG. 4 shows the effect on soot formation.

This concentrate can also be mixed at any level of dilution to form a stable (over weeks of storage) and clear emulsion compared to the same emulsion without maleate. This is due to the small average particle size (about 250 nm) and the matching of the index of refraction of the aqueous droplets (which are 63 wt % ammonium maleate) with that of diesel fuel (n_{D}=1.4648). One specific fuel was made by mixing 7 wt % of this concentrate with 93% wt diesel fuel to give a composition shown in Table 2. This fuel, when burned in a diesel engine, gives lower NOx emissions than the corresponding diesel base fuel.

### EXAMPLE 2

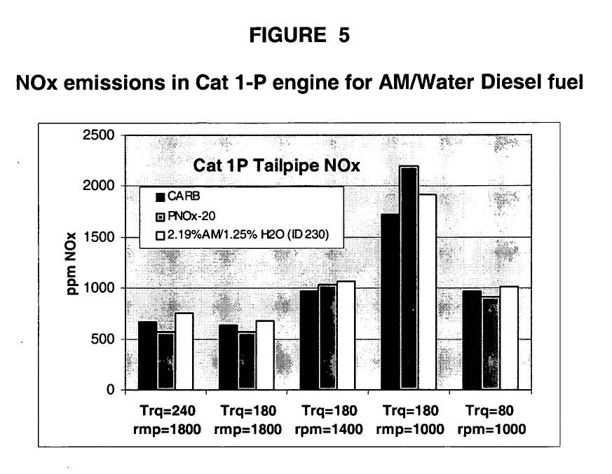

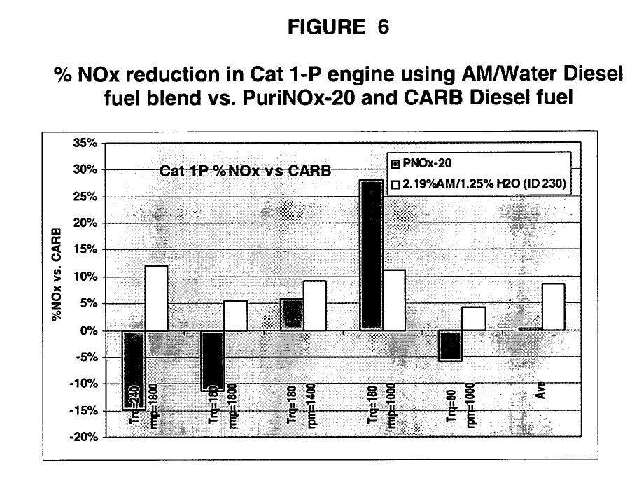

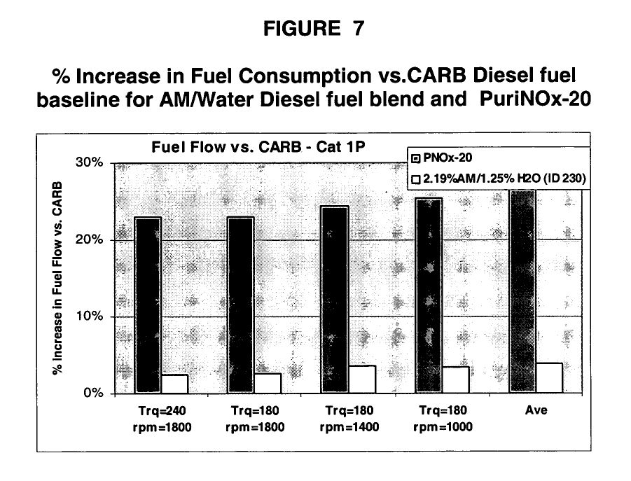

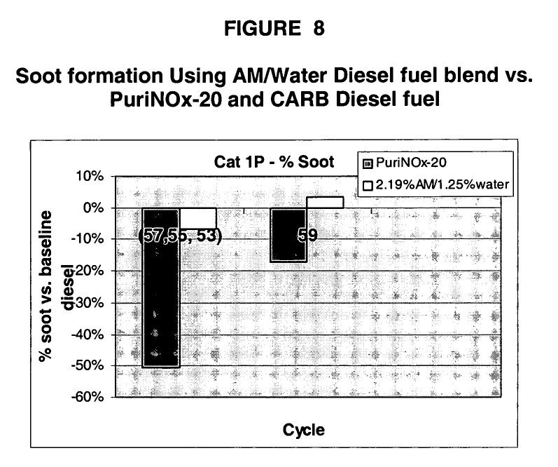

The same composition and the same engine tests were repeated. The results are shown in the FIGS. 5 to 8.

This example demonstrates that the emulsifier fuel of the water forms stable clear emulsions. The emulsified fuel further gives lower NOx emissions compared to the corresponding fuels.

This example demonstrates that the emulsified fuel of the invention forms stable clear emulsions. The emulsified fuel further gives lower Nox emission compared to the corresponding fuels.

1. An emulsified fuel composition comprising water, fuel, at least one emulsifier, and at least one aqueous organic ammonium salt wherein the organic ammonium salt is selected from a group consisting of 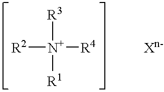
in which R¹, R², R³ and R⁴ are identical or different and independently of one another are hydrogen; or an organic substitute having up to 18 C atoms which is bonded via a C—N bond; or a saturated or unsaturated alkyl group, aryl group, or saturated or unsaturated alkyl group, aryl group substituted with a heteroatom selected from the group comprising N, O, S, P, and a halogen atoms, where R averages from about 4 to about 20 carbon atoms, preferably from about 7 to about 12 carbon atoms; or at least one of the radicals R¹, R², R³ and R⁴ being other than hydrogen and Xⁿ⁻ being an anion of an inorganic or organic n-basic acid, and n being 1, 2, or 3 and resulting in an emulsified fuel wherein the fuel phase is a continuous phase and the aqueous phase is a discontinued phase and wherein the aqueous phase is comprised of droplets having a mean droplet of about 1.0 micron or less,
resulting in a water and fuel emulsion wherein the fuel phase is a continuous phase and the aqueous phase is a discontinuous phase and wherein the water phase is comprised of droplets having a mean droplet of 1.0 micron or less.

2. The composition of claim 1, wherein the organic ammonium salt is selected from a group consisting of 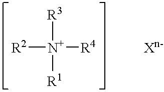
in which R¹, R², R³ and R⁴ are identical or different and independently of one another are hydrogen; or an organic substitute having up to 18 C atoms which is bonded via a C—N bond; or a saturated or unsaturated alkyl group, aryl group, or saturated or unsaturated alkyl group, aryl group substituted with a heteroatom selected from the group comprising N, O, S, P, and a halogen atoms, where R averages from about 4 to about 20 carbon atoms, preferably from about 7 to about 12 carbon atoms; or at least one of the radicals R¹, R², R³ and R⁴ being other than hydrogen and Xⁿ⁻ being an anion of an inorganic or organic n-basic acid, and n being 1, 2, or 3 and resulting in an emulsified fuel wherein the fuel phase is a continuous phase and the aqueous phase is a discontinued phase and wherein the aqueous phase is comprised of droplets having a mean droplet of about 1.0 micron or less.

3. The fuel composition of claim 1 wherein Xⁿ⁻ is selected from the group consisting of anions whose conjugate acid of the formula HₙX has a pka <10; halogen atoms; and combinations thereof.

4. The composition of claim 3 wherein the Xⁿ⁻ is selected from the group consisting of chlorine, bromine, and anion of a protic acid, carboxylic acids, perchloric acid, carbonic acid, and mixtures thereof.

5. The composition of claim 1 wherein the organic ammonium salts is selected from the group consisting of ammonium hydroxides, ammonium sulfates, ammonium sulfites, ammonium paratoluenesulfonates, ammonium nitrates, ammonium acetates, ammonium halides ammonium alkanoates, ammonium sulfonates, ammonium phosphonates, ammonium chlorates, ammonium salts of aromatic or heteroaromatic carboxylic acids and combinations thereof.

6. The composition of claim 2 wherein the organic ammonium salts are selected from the group consisting of primary organic ammonium salts such as stearyl ammonium acetate, oleylammonium acetate, tallow fatty amine acetate, coconut fatty amine oleate, coconut fatty amine acetate, tallow fatty propylenediaminoacetate and combinations thereof;
secondary organic ammonium salts such as dialkylammonium chlorides;
tertiary organic ammonium salts such as cetyldimethylammonium chloride, and oleyldimethylammonium chloride;
quaternary organic ammonium salts such as hexadecyltrimethylammonium chloride, hexadecyltrimethylammonium chloride, soya alkyltrimethylammonium chloride, coconut alkyldimethylbenzylammonium chloride, coconut alkyldimethylbenzylammonium chloride, coconut alkyl-2, 4-dichlorobenzyldimethylammonium chloride, stearyldimethylbenzylammonium chloride, di-coconut alkyldimethylammonium chloride, disteryldimethylammoniumchloride, quaternary dialkylammonium chloride, di-tallow fatty alkyldimethylammonium chloride, alkyltrimethylammononium chlorides, distearyldimethylammonium chloride, didecylmethylpolyoxyethylammonium propionate, di-fatty acid dimethylammonium chlorides, benzyltrimethylammonium chlorides and combinations thereof.

7. The composition of claim 1 wherein the organic ammonium salts are in the range of 0.1% to about 35% by weight of the emulsified fuel.

8. The composition of claim 1 wherein the aqueous organic ammonium salts are in the range of about 0.5% to about 10% by weight of emulsified fuel.

9. The composition of claim 1 comprising other additives selected from the group consisting of cetane improvers, organic solvents, antifreeze agents, dyes, rust inhibitors, alkylated succinic acids and anhydrides, bacteriostatic agents, gum inhibitors, metal deactivators, upper cylinder lubricants, alcohols, antifreeze agents, and combinations thereof.

10. The composition of claim 1, wherein the fuel phase is a continuous phase and the aqueous phase is a discontinuous phase and wherein the water phase is comprised of droplets having a mean droplet of 1.0 micron or less.

11. A process to make an emulsified fuel comprising emulsifying a fuel, a water, at least one emulsifier wherein the emulsifier comprises
(i) at least one fuel-soluble product made by reacting at least one hydrocarbyl-substituted carboxylic acid acylating agent with ammonia or an amine selected from the group consisting of alkanol amine, hydroxy amine, and the combinations thereof, the hydrocarbyl substituent of said acylating agent having about 50 to about 500 carbon atoms;
(ii) a second acylating agent having at least one hydrocarbyl substituents of up to about 40 carbon atoms, and reacting that said acylating agent with ammonia or an amine;
(iii) at least one of an ionic or a nonionic compound having a hydrophilic-lipophilic balance (HLB) of about 1 to about 40;
(iv) mixture of (ii) or (iii) with (i) or a mixture of (i), (ii), and (iii);
(v) a water-soluble compound comprising amine salts, ammonium salts, azide compounds, nitrate esters, nitramine, nitrocompounds, alkali metal salts, alkaline earth metal salts, in combination with (i), (ii), (iii), (v), (vii) or combinations thereof;
(vi) the reaction product of polyacidic polymer with at least one fuel soluble product made by reacting at least one hydrocarbyl-substituted carboxylic acid acylating agent with ammonia, an amine, a polyamine, an alkanol amine or hydroxy amines;
(vii) an amino alkylphenol which is made by reacting an alkylphenol, an aldehyde and an amine resulting in an amino alkylphenol, or
(viii) the combination thereof,
and at least one aqueous organic ammonium salt resulting in a water and fuel emulsion wherein the fuel phase is a continuous phase and the aqueous phase is a discontinuous phase and wherein the water phase is comprised of droplets having a mean droplet of 1.0 micron or less.

12. The process of claim 11 to produce an emulsified fuel from a concentrate that is formed from all or substantially all the water, all or substantially all organic ammonium salt, and a portion of the fuel and all or substantially all the emulsifier which is then blended to form a concentrate and then the concentrate is later blended with the rest of the portion of fuel.

13. The process of claim 11 wherein the emulsifier comprises
(i) at least one fuel-soluble product made by reacting at least one hydrocarbyl-substituted carboxylic acid acylating agent with ammonia or an amine selected from the group consisting of alkanol amine, hydroxy amine, and the combinations thereof, the hydrocarbyl substituent of said acylating agent having about 50 to about 500 carbon atoms;
(ii) a second acylating agent having at least one hydrocarbyl substituents of up to about 40 carbon atoms, and reacting that said acylating agent with ammonia or an amine;
(iii) at least one of an ionic or a nonionic compound having a hydrophilic-lipophilic balance (HLB) of about 1 to about 40;
(iv) mixture of (ii) or (iii) with (i) or a mixture of (i), (ii), and (iii);
(v) a water-soluble compound selected from the group consisting of amine salts, ammonium salts, azide compounds, nitrate esters, nitramine, nitrocompounds, alkali metal salts, alkaline earth metal salts, in combination with (i), (ii), (iii), (v), (vii) or combinations thereof;
(vi) the reaction product of polyacidic polymer with at least one fuel soluble product made by reacting at least one hydrocarbyl-substituted carboxylic acid acylating agent with ammonia, an amine, a polyamine, an alkanol amine or hydroxy amines;
(vii) an amino alkylphenol which is made by reacting an alkylphenol, an aldehyde and an amine resulting in an amino alkylphenol, or
(viii) the combination thereof.

14. The process of claim 11, wherein an additional additives comprising of cetane improvers, dyes, rust inhibitors, alkylated succinic acids and anhydrides, bacteriostatic agents, gum inhibitors, metal deactivators, upper cylinder lubricants, alcohols, antifreeze agents, and combinations thereof.

15. The process of claim 11, wherein the emulsified fuel has a concentration of fuel at about 50% to about 95% by weight, water is in the range of about 1% to about 50% by weight, the emulsifier is in the range of about 0.01% to about 20% by weight and additional additives are in the range of about 0% to 10% by weight by weight of the emulsified fuel.

16. The process of claim 11, wherein the emulsified fuel has a concentration of fuel at about 60% to about 95% by weight, water is in the range of about 5% to about 40% by weight, the emulsifier is in the range of about 0.05% to about 10% by weight and additional additives are in the range of about 0.1% to 10% by weight of the emulsified fuel.

17. The composition of claim 1 used to reduce NOx emissions in engines.

18. An emulsified water and fuel composition that employs a fuel, a water, at least one emulsifier and at least one aqueous organic ammonium salt to reduce NOx emission in engines.

19. An emulsified water and fuel composition that employs a fuel, a water, at least one emulsifier and at least one aqueous organic ammonium salt used in conjunction with after treatment devices on engines.

20. An emulsified fuel composition comprising water, fuel, at least one emulsifier, and at least one aqueous organic ammonium salt comprising 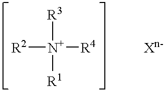
in which R¹, R², R³ and R⁴ are identical or different and independently of one another are hydrogen; or an organic substitute having up to 18 C atoms which is bonded via a C—N bond; or a saturated or unsaturated alkyl group, aryl group, or saturated or unsaturated alkyl group, aryl group substituted with a heteroatom selected from the group comprising N, O, S, P, and a halogen atoms, where R averages from about 4 to about 20 carbon atoms, preferably from about 7 to about 12 carbon atoms; or at least one of the radicals R¹, R², R³ and R⁴ being other than hydrogen and Xⁿ⁻ being an anion of an inorganic or organic n-basic acid, and n being 1, 2, or 3, resulting in a water and fuel emulsion.
